(19) United States
(12) Patent Application Publication
(10) Pub. No.: US 2011/0015332 A1
(43) Pub. Date: Jan. 20, 2011

(54) Oil-in-water aminosiloxane emulsions

(75) Inventors: Nadia MARTIN, Lyon (FR); Yves Giraud, Sainte Foy Les Lyon (FR); Martial Deruelle, Mornant (FR)

Correspondence Address: BUCHANAN, INGERSOLL & ROONEY PC, POST OFFICE BOX 1404, ALEXANDRIA, VA, 22313-1404, US

(73) Assignee: Bluestar Silicones France, Lyon (FR)

(21) Appl. No.: 12/764,527

(22) Filed: Apr. 21, 2010

Related U.S. Application Data
(63) Continuation of application No. 12/308,933, now abandoned.

(30) Foreign Application Priority Data
Jun. 30, 2006 (FR) 0605938

(51) Int. Cl. C08L 83/04

(52) U.S. Cl. 524/500; 524/588

(57) ABSTRACT

Oil-in-water siloxane emulsions are useful for providing a substrate, especially a textile substrate, with long-lasting water-repellent properties.

The field of the present invention is that of silicone oil-in-water emulsions that can be used to waterproof a substrate, in particular a textile substrate, in a long-lasting manner.

Liquid silicone waterproofing compositions exist either in the form of solutions in organic solvents such as white spirit or heptane, or in the form of aqueous emulsions which have appeared more recently on the market. Conventionally, after impregnation, the organic solvent phase or the aqueous phase of these compositions volatilizes and the silicone active material remains on or in the mass of the substrate treated, so as to form a barrier against moisture.

For reasons of cost, hygiene, safety and environmental friendliness, the replacement of solvent-phase liquid silicone waterproofing compositions with aqueous silicone emulsions is sought.

For example, in the textile field, waterproofing consists in preventing water from passing through a fabric, while at the same time preserving the air-porosity of said fabric. For the waterproofing of clothing, one of the desired characteristics is permanence of the treatment. In practice, it is observed that the many current formulations do not make it possible to achieve satisfactory durabilities.

The waterproof nature of a textile support provides it with a water-repellency effect (or water-repellent property) and good water-impermeability.
The water-repellent property is a characteristic of the surface of the textile. It corresponds to the fact that, with moderate sprinkling (representative of light rain), the water does not attach to the textile, which as a result emerges more or less dry.
Liquid water-impermeability is a characteristic rather of the bulk of the textile, in the sense that the water must not invade and pass through the porosity of the textile surface. The number and the size of the pores are to be taken into consideration, but also the surface treatment of these pores (surface of woven or knitted fibers).

Providing a textile material with all these functions is already in itself a technical feat.

Among the principal agents conventionally used for providing a textile support with a waterproof nature, the following stand out:
carboxylic acids containing aluminum and zirconium salts, which are not wash-fast,
emulsions of paraffins, which are relatively unstable and not wash-fast, unless combined with salts, and
modified melamines which provide a good water-repellency effect, good impermeability and good wash-fastness.

However, providing the textile material with long-lasting functions is an additional technical difficulty. It is known (cf. patent DE-A-2 822393) that, in order to improve anchorage, it is desirable to produce covalent chemical bonds between the support and the compound that one is seeking to deposit on the textile surface. However, given the nature and the diversity of the polymers used to manufacture textile materials, this option is not always possible and, when it is, it remains specific to a certain type of support textile material.

Obtaining textiles exhibiting the properties mentioned above, in a long-lasting manner, in particular a strong water-repellent property, may prove to be very advantageous for the textile market. In addition, it will be emphasized that, for this type of application, the persistence of the properties under conditions of wet abrasion, and most particularly when subjected to washing, is essential.

Patent application US-A-2006/0041026 describes the use of an oil-in-water emulsion comprising a polydimethyl-siloxane comprising aminoalkyl groups, an emulsifier at a content of less than 5 parts by weight and a protonating agent which is an acid and the presence of which is necessary in order to stabilize the emulsion even when it is diluted, as is taught in patent EP 556740 cited as prior art in this reference.

However, the obligatory presence of an acid in this type of formulation is prejudicial in terms of industrial manufacture, which requires the handling and storage of compounds presenting environmental and safety risks.

One of the essential objectives of the present invention is to provide a composition which makes it possible to provide a large number of porous or nonporous, absorbent or nonabsorbent substrates, and in particular textile materials, with long-lasting water-proofing.

Another objective is to provide a method for the long-lasting waterproofing of a porous or nonporous, absorbent or nonabsorbent substrate, and in particular a textile substrate. This treatment thus makes it possible to confer strong water-repellent properties on the treated substrate, in particular a textile substrate, in a long-lasting manner, and without substantially calling into question the intrinsic breathability properties when the treated material is a textile.

These objectives, among others, are achieved by virtue of the present invention, which relates to a composition, in the form of an oil-in-water emulsion, based on siloxane, constituted essentially:
of at least one aminopolyorganosiloxane (A),
of water,
of at least one surfactant (B), and
optionally, of at least one polyorganosiloxane resin (C), and
optionally, of at least one epoxy-functionalized polyorganosiloxane (D),
optionally, of at least one additive (E) chosen from the group constituted of biocides, antifungal agents, antifoams, antioxidants, film-forming polymers, thickeners and wetting agents,
   with, as additional conditions, the fact that:
1) the surfactant (B) is present at up to 2.5% by weight, preferably up to 2% by weight, relative to the sum of the weights of the constituents (A), (C) and (D), and
2) the amounts of surfactants (B) and of water are sufficient to obtain an oil-in-water emulsion.

In order to achieve this objective, among others, the inventors have, to their credit, entirely surprisingly and unexpectedly updated the fact that for waterproofing a substrate, in particular a textile material, in a long-lasting manner, an oil-in-water emulsion according to the invention makes it possible to do away with the addition of a protonating agent such as formic acid, acetic acid, sulfuric acid, hydrochloric acid or citric acid. This has the advantage of eliminating any environmental risk or risk in terms of safety linked to the use or storage of acid in an industrial production line.

The inventors have had to show a great deal of inventiveness, since it was necessary for them to go against the technical prejudice solidly anchored in normal practices, according to which the addition of a protonating agent is necessary from the viewpoint of the stabilization of aminosilicone emulsions and consequently from the viewpoint of the effectiveness thereof.

In the present report, the expression “textile material” denotes: on the one hand, yarns, fibers and/or filaments made of synthetic and/or natural materials which are used for the manufacture of textile articles; and, on the other hand, the textile articles themselves, comprising at least one textile surface and consisting, for example, of woven, nonwoven and/or knitted articles; by extension, the expression “textile material” also denotes materials of which the basic texture is in fibrillar form, such as, in particular, paper and leather.

The composition according to the present invention may be used directly on the substrate to be treated, in particular textile articles comprising at least one textile surface and consisting, for example, of woven, nonwoven and/or knitted articles.

The term “textile surface” is intended to mean a surface obtained by assembling yarns, fibers and/or filaments by any process, such as, for example, adhesive bonding, felting, weaving, braiding, flocking or knitting.

The yarns, fibers and/or filaments which are used for the manufacture of these textile articles can result from the conversion of a synthetic thermoplastic matrix composed of at least one thermoplastic polymer chosen from the group consisting of: polyamides, polyolefins, polyvinylidene chlorides, polyesters, polyurethanes, acrylonitriles, (meth)acrylate/butadiene/styrene copolymers, copolymers thereof and blends thereof. The thermoplastic matrix may comprise additives, such as pigments, delustrants, matifying agents, catalysts, heat and/or light stabilizers, antibacterial agents, antifungal agents and/or anti-acarid agents. It may, for example, be a matifying agent, for example chosen from particles of titanium dioxide and/or of zinc sulfide.

The yarns, fibers and/or filaments may also result from natural materials such as, in particular, cotton, flax or wool, according to conversion processes known to those skilled in the art. Of course, mixtures of synthetic and natural materials may be used.

The durability of the treatment and of the abovementioned properties is essential. The durability can be assessed in a context including the washing of the textile material. Tests carried out by the applicant under drastic washing conditions have made it possible to show the notable fastness of the treatment with the composition according to the invention, correlated with a persistence of the properties. This durability can be measured by comparing the performance levels of the treated textile material, before and after having subjected this material to an intensive washing protocol, the material being spin-dried and dried before being subjected to the property test protocol(s).

The beading effect (water-repellent property) can be measured by the spray-test method, AATC Test Method 22-1996; this method is described in the examples and may consist of a visual evaluation of the wetted appearance of the sample: the test consists in sprinkling the sample of the textile article with a given volume of water; the appearance of the sample is then evaluated visually and optionally compared with a standard; a mark is assigned according to the amount of water retained.

The measurement of the durability of the water-repellent properties makes it possible to assess the durability of the silicone treatment according to the invention. The other properties provided by the combination between the textile, these constitutive yarns, fibers or filaments, and the silicone treatment also benefit from this durability.

According to one preferred embodiment, the aminopolyorganosiloxane (A) comprises siloxyl units, which may be identical or different, of general formula (I):

R¹ₐR²_{b}SiO_{4-(a+b)/2} (I)

in which:
(a) a=0, 1, 2 or 3,
   b=0, 1, 2 or 3,
   a+b≦3,
(b) the symbols R¹ are identical or different and each represent a monovalent hydrocarbon-based radical chosen from linear or branched alkyl radicals containing from 1 to 40 carbon atoms, and —OR³ radicals with R³=H or a linear or branched alkyl radical containing from 1 to 40 carbon atoms, and
(c) the symbols R² are radicals which are identical or different and represent radicals of general formula (II):

—R⁴—N(R⁵)(R⁶) (II)
with:
   the symbol R⁴ being a divalent hydrocarbon-based group containing from 1 to 40 carbon atoms,
   the symbol R⁵ being a hydrogen atom or a monovalent hydrocarbon-based group containing from 1 to 40 carbon atoms,
   the symbol R⁶ being a hydrogen atom or a radical of formula (III)

—[R⁷—N(R⁸)]ₓR⁸
the symbol R⁷ being a divalent radical of formula (IV)

—[C(R⁸)(R⁸)—]_{y}
0≦x≦40,
y=1, 2 or 3,
the symbol R⁸ is a hydrogen atom or a monovalent hydrocarbon-based group containing from 1 to 40 carbon atoms, and
(d) at least one siloxyl unit bearing an R² group is present per molecule.

As examples of radicals R² that are useful according to the invention, mention may be made of the following radicals:

### —CH₂—NH₂

### —CH₂—NH—C₆H₅

### —CH₂—NH—C₆H₁₁

—CH₂—NH— (C₂H₄O)ⱼ[C₂H₃(CH₃)O]ₖH

### —C₃H₆—NH₂

### —C₃H₆—NH—C₆H₅

### —C₃H₆—NH—C₆H₁₁

—C₃H₆—NH—(C₂H₄O)ⱼ[C₂H₃(CH₃)O]ₖH
—C₃H₆—NH— (C₂H₄—NH)ᵢ(C₂H₄O)ⱼ[C₂H₃(CH₃)O]kH

### —C₃H₆—NH—C₂H₄—NH₂

### —C₃H₆—NH—C₂H₄—NH—C₆H₅

### —C₃H₆—NH—C₂H₄—NH—C₆H₁₁

—C₃H₆—NH—C₂H₄—NH— (C₂H₄O)ⱼ[C₂H₃(CH₃)O]ₖH

### —C₃H₆—NH—C₃H₆

### —C₃H₆—O—C₅H₄(CH₃)₄NH

### —CH₂CH(CH₃)CH₂—NH—C₂H₄—NH₂

### —CH₂CH(CH₃)CH₂—NH—C₂H₄—NH—C₆H₅

### —CH₂CH(CH₃)CH₂—NH—C₂H₄—NH—C₆H₁₁

### —C₃H₆—NH—C₂H₄—NH—C₂H₄—NH₂

### —C₁₈H₃₆—NH₂

The indices i, j and k are integers, which may be identical or different, between 0 and 20, the sum i+j+k preferably being between 0 and 30.

It is particularly advantageous for the R² radical described in formula (I) above to be chosen from the group constituted of:

—(CH₂)₃—N(R⁵)₂; —(CH₂)₃—N(R⁵)₂— and —(CH₂)₃—N(R⁵)—(CH₂)₂—N(R⁵)₂ with the symbol R⁵ being a hydrogen atom or a monovalent hydrocarbon-based group containing from 1 to 40 carbon atoms.

According to another preferred embodiment, the R² radical is chosen from the group constituted of the following radicals: —(CH₂)₃—NH₂ and —(CH₂)₃—NH— (CH₂)₂—NH₂.

The nature of surfactant (B) will be readily determined by those skilled in the art, the objective being to prepare a stable emulsion. Anionic, cationic, nonionic and zwitterionic surfactants may be used alone or as a mixture.

By way of anionic surfactant, mention may be made of the following surfactants:
alkyl ester sulfonates of formula R^{a}—CH(SO₃M)-COOR^{b}, where R^{a} represents a C₈-C₂₀, preferably C₁₀-C₁₆, alkyl radical, R^{b} a C₁-C₆, preferably C₁-C₃, alkyl radical and M an alkali metal cation (sodium, potassium, lithium), a substituted or unsubstituted ammonium (methyl-, dimethyl-, trimethyl-, tetramethylammonium, dimethylpiperidinium) or a derivative of an alkanolamine (monoethanolamine, diethanolamine, tri-ethanolamine),
alkyl sulfates of formula R^{c}OSO₃M, where R^{c} represents a C₁₀-C₂₄, preferably C₁₂-C₂₀, alkyl or hydroxyalkyl radical, M representing a hydrogen atom or a cation having the same definition as above, and also the ethoxylenated (EO) and/or propoxylenated (PO) derivatives thereof having preferably from 1 to 20 EO units,
alkylamide sulfates of formula R^{d}CONHR^{e}OSO₃M where R^{d} represents a C₂-C₂₂, preferably C₆-C₂₀, alkyl radical, R^{e} a C₂-C₃ alkyl radical, M representing a hydrogen atom or a cation having the same definition as above, and also the ethoxylenated (EO) and/or propoxylenated (PO) derivatives thereof having preferably 1 to 20 EO units,
salts of saturated or unsaturated C₈-C₂₄, preferably C₁₄-C₂₀ fatty acids, C₉-C₂₀ alkylbenzenesulfonates, and also the ethoxylenated (EO) and/or propoxylenated (PO) derivatives thereof having preferably 1 to 20 EO units,
C₉-C₂₀ alkylbenzenesulfonates, primary or secondary C₈-C₂₂ alkyl sulfonates, alkyl glyceryl sulfonates, the sulfonated polycarboxylic acids described in GB-A-1 082 179, paraffin sulfonates, N-acyl N-alkyl taurates, mono- and dialkyl phosphates, alkyl isethionates, alkyl succinamates, alkyl sulfosuccinates, sulfosuccinate monoesters or diesters, N-acyl sarcosinates, alkylglycoside sulfates, polyethoxycarboxylates, the cation being an alkali metal (sodium, potassium, lithium), a substituted or unsubstituted ammonium residue (methyl-, dimethyl-, trimethyl-, tetramethylammonium, dimethylpiperidinium) or a derivative of an alkanolamine (monoethanolamine, diethanolamine, triethanolamine).

By way of nonionic surfactants, mention may be made of poly(alkylene oxide) alkyl or aryl ethers, polyoxy-ethylenated sorbitan hexastearate, polyoxyethylenated sorbitan oleate and cetylstearyl ethers of poly-(ethylene oxide). By way of poly(alkylene oxide) aryl ether, mention may be made of polyoxyethylenated alkyl-phenols. By way of poly(alkylene oxide) alkyl ether, mention may be made of polyethylene glycol isodecyl ether and polyethylene glycol trimethylnonyl ether containing from 3 to 15 ethylene oxide units per molecule.

By way of example of a surfactant, mention may also be made of ionic, nonionic or amphoteric fluorinated surfactants, and mixtures thereof, for example:
perfluoroalkyls,
perfluorobetains,
ethoxylated polyfluoroalcohols,
polyfluoroalkylammoniums,
surfactants in which the hydrophilic part contains one or more saccharide unit(s) bearing from five to six carbon atoms and in which the hydrophobic part contains a unit of formula Rf(CH₂)ₙ—, in which n=2 to 20 and Rf represents a perfluoroalkyl unit of formula CₘF₂ₘ₊₁, in which m=1 to 10; and
polyelectrolytes exhibiting fatty perfluoroalkyl side groups.

The term “fluorinated surfactant” is intended to mean, as is entirely known per se, a compound made up of an aliphatic perfluorocarbon-based part, comprising at least three carbon atoms, and an ionic, nonionic or amphoteric hydrophilic part. The perfluorocarbon-based part of at least three carbon atoms may represent either all, or only a fraction, of the fluorocarbon-based part of the molecule. As regards this type of compound, a large number of references are found in the literature. Those skilled in the art may refer in particular to the following references:
FR-A-2 149 519, WO-A-94 21 233, U.S. Pat. No. 3,194,767, the book “Fluorinated Surfactants”, Erik Kissa, published by Marcel Dekker Inc., Chapter 4, in particular tables 4.1 and 4.4.

Mention may in particular be made of the products sold by the company DU PONT under the name Zonyl®, for example FSO, FSN-100, FS-300 and FSD, and also the fluorinated surfactants known as Forafac® distributed by the company DU PONT and the products sold under the name Fluorad® by the company 3M.

Among these surfactants, mention will in particular be made of anionic, cationic, nonionic and amphoteric perfluoroalkylated compounds, and among them, more particularly, the surfactants of the Zonyl® class sold by DU PONT, e.g.:
F(CF₂CF₂)₃₋₈CH₂CH₂SCH₂CH₂COOLi (anionic),
F(CF₂CF₂)₃₋₈CH₂CH₂O(CH₂CH₂O)_{y}H with v being a variable integer (nonionic),
F(CF₂CF₂)₃₋₈CH₂CH₂SCH₂CH₂N+(CH₃)₃CH₃SO₄— (amphoteric), and
F(CF₂CF₂)₃₋₈CH₂CH(OCOCH₃)CH₂N+(CH₃)₂CH₂CH₂CO₂— (amphoteric),
   sold by DU PONT respectively under the names Zonyl® FSA, Zonyl® FSO, Zonyl® FSC and Zonyl® FSK.

The following may also be specified with respect thereto:
Zonyl® FSO 100: CAS 65545-80-4, (nonionic) 99% to 100%, the remainder being 1,4-dioxane
Zonyl® FSN: CAS 65545-80-4, 99% to 100%, the remainder being sodium acetate and 1,4-dioxane
Zonyl® FS-300: CAS 65545-80-4, 40%, the remainder being 1,4-dioxane (<0.1%) and water
Zonyl® FSD: CAS 70983-60-7, 30%, (cationic), the remainder being hexylene glycol (10%), sodium chloride (3%) and water (57%).

Mention may also be made of:
perfluoroalkyl betains (amphoteric) such as that sold by DU PONT under the name Forafac® 1157, ethoxylated polyfluoroalcohols (nonionic), such as that sold by DU PONT under the name Forafac 1110 D, polyfluoro-alkylammonium salts (cationic), such as that sold by DU PONT under the name Forafac 1179;
surfactants in which the hydrophilic part contains one or more saccharide unit(s) containing from 5 to 6 carbon atoms (units derived from sugars such as fructose, glucose, mannose, galactose, talose, gulose, allose, altose, idose, arabinose, xylose, lyxose and/or ribose) and in which the hydrophobic part contains a unit of formula R_{F}(CH₂)ₙ, where n may range from 2 to 20, preferably from 2 to 10, and R_{F} represents a perfluoroalkyl unit of formula CₘF₂ₘ₊₁ with m possibly ranging from 1 to 10, preferably from 4 to 8, chosen from those having the characteristics defined above; mention may be made of monoesters of perfluoroalkylated fatty acids and of sugars such as □,□-trehalose and sucrose, it being possible for the monoester function to be represented by the formula R_{F}(CH₂)ₙC(O), where n can range from 2 to 10 and R_{F} represents a perfluoroalkyl unit of formula CₘF₂ₘ₊₁ with m possibly ranging from 4 to 8, described in JAOCS, Vol. 69, No. 1 (January 1992) and chosen from those having the characteristics defined above; and
polyelectrolytes exhibiting fatty perfluoroalkyl side groups, such as polyacrylates exhibiting R_{F}(CH₂)ₙ groups where n can range from 2 to 20, preferably from 2 to 10, and R_{F} represents a perfluoroalkyl unit of formula CₘF₂ₘ₊₁ with m possibly ranging from 1 to 10, preferably from 4 to 8, chosen from those having the characteristics defined above; mention may be made of the polyacrylates exhibiting —CH₂C₇F₁₅ groups described in J. Chim. Phys. (1996) 93, 887-898 and chosen from those having the characteristics defined above.

As an example of polyorganosiloxane resins (C) that are useful according to the invention, mention may be made of organosilicon resins prepared by cohydrolysis and cocondensation of chlorosilanes chosen from the group constituted of those of formulae (R⁹)₃SiCl, (R⁹)₂Si(Cl)₂, R⁹Si(Cl)₃ and Si(Cl)₄. The R⁹ radicals are identical or different and are chosen from linear or branched C₁-C₆ alkyl radicals, C₂-C₄ alkenyl radicals, phenyl and 3,3,3-trifluoropropyl. As alkyl radicals R⁹, mention may, for example, be made of methyl, ethyl, isopropyl, tert-butyl and n-hexyl radicals. These resins are branched organopolysiloxane oligomers or polymers which are well known and commercially available. They have, in their structure, at least two different siloxyl units chosen from those of formulae (R⁹)₃SiO_{1/2} (unit M), (R⁹)₂SiO_{2/2} (unit D), R⁹SiO_{3/2} (unit T) and SiO_{4/2} (unit Q), at least one of these units being a T or Q unit. The R⁹ radicals are distributed such that the resins comprise approximately from 0.8 to 1.8 R⁹ radicals per silicon atom. Furthermore, these resins are not completely condensed and they also have approximately from 0.001 to 1.5 OH and/or alkoxyl groups per silicon atom. As examples of branched organopolysiloxane oligomers or polymers, mention may be made of MQ resins, MDQ resins, TD resins and MDT resins, it being possible for the OH and/or alkoxyl groups to be borne by the M, D and/or T units, the content by weight of OH and/or alkoxyl groups being between 0.2% and 10%.

Preferably, the polyorganosiloxane resin (C) is a liquid polyorganosiloxane resin of T(OH), DT(OH), DQ(OH), DT(OH), MQ(OH), MDT(OH) or MDQ(OH) type, or mixtures thereof.

As epoxy-functionalized polyorganosiloxane (D) that is useful according to the invention, mention may be made of polyorganosiloxanes comprising at least one epoxy-functional radical Y, linked to the silicon by means of a divalent radical containing from 2 to 20 carbon atoms and capable of containing at least one heteroatom, preferably oxygen, bearing at least one epoxy unit, Y preferably being selected from the following radicals:

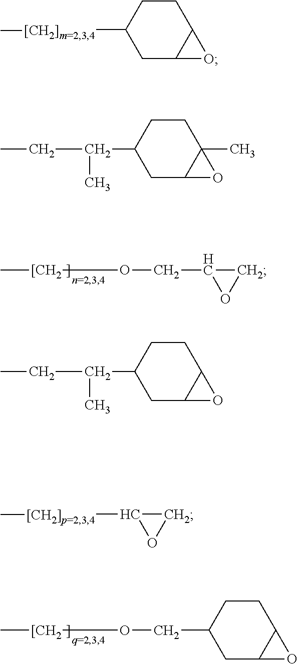

According to one preferred embodiment of the invention, the epoxy-functionalized polyorganosiloxane (B) is constituted of units of formula (V) and terminated with units of formula (VI) and/or constituted of units of formula (V) represented below:

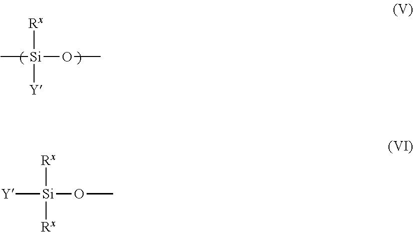

in which:
the symbols R^{x} are similar or different and represent:
   a linear or branched alkyl radical containing 1 to 8 carbon atoms, the alkyl radicals preferably being methyl, ethyl, propyl and octyl,
   an optionally substituted cycloalkyl radical containing between 5 and 8 cyclic carbon atoms,
   an aryl radical containing between 6 and 12 carbon atoms, which may be substituted, preferably phenyl or dichlorophenyl,
   an aralkyl part having an alkyl part containing between 5 and 14 carbon atoms and an aryl part containing between 6 and 12 carbon atoms, which is optionally substituted, on the aryl part, with halogens, alkyls and/or alkoxyls containing 1 to 3 carbon atoms,
the symbols Y′ are similar or different and represent:
   the R^{x} group, and/or
   an epoxy-functional group, linked to the silicon of the polyorganosiloxane by means of a divalent radical containing from 2 to 20 carbon atoms and capable of containing at least 1 heteroatom, preferably oxygen,
   with at least one of the symbols Y′ representing an epoxy-functional group.

According to one preferred embodiment of the invention, the organofunctional groups Y′ of the epoxy type are chosen from the following formulae:

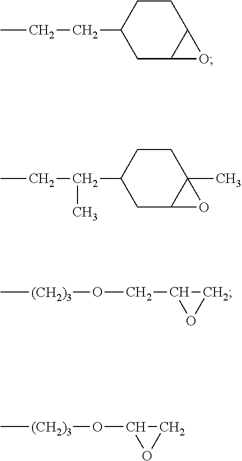

The epoxy-functionalized polyorganosiloxane (D) may be either linear or cyclic. When it is a case of cyclic polyorganosiloxanes, the latter are constituted of units (V) which may be, for example, of the dialkylsiloxy or alkylarylsiloxy type. These cyclic polyorganosiloxanes have a viscosity of the order of 1 to 5000 mPa·s.

The obtaining of such functionalized polyorganosiloxanes is entirely within the scope of those skilled in the art of silicone chemistry.

According to another preferred embodiment, the composition according to the invention, in the form of an oil-in-water emulsion, based on siloxane, is essentially constituted:
of 100 parts by weight of at least one aminopolyorganosiloxane (A),
of water,
of at most 2.5 parts by weight of at least one surfactant (B), and
of 0 to 600 parts by weight of at least one poly-organosiloxane resin (C),
of 0 to 5 parts by weight of at least one additive (E) chosen from the group constituted of biocides, antifungal agents, antifoams, antioxidants, film-forming polymers, thickeners and wetting agents,
   with, as additional conditions, the fact that:
1) the surfactant (B) is present at up to 2.5% by weight, preferably up to 2% by weight, relative to the sum of the weights of the constituents (A) and (C), and
2) the amounts of surfactants (B) and of water are sufficient to obtain an oil-in-water emulsion.

Another subject of the invention consists of a method for the long-lasting waterproofing of a substrate, it being possible for said substrate to be porous or nonporous, absorbent or nonabsorbent, characterized in that said substrate is brought into contact with the composition in the form of an oil-in-water emulsion according to the invention as defined above.

As examples of a substrate, mention may be made of the following substrates: textiles, stones, concretes, mortars, bricks, tiles and wood.

According to one preferred embodiment, the substrate is a textile material.

According to another embodiment, the composition according to the invention is used at a content of 5% by weight of polyorganosiloxanes when the substrate is a textile material so as not to damage its properties to the touch.

The final subject of the invention consists of the use of a composition according to the invention for the long-lasting waterproofing of a porous or nonporous, absorbent or nonabsorbent substrate as defined above.

Other advantages and characteristics of the present invention will emerge on reading the following examples, given by way of illustration which is in no way limiting.

### EXAMPLES

### 1) Methodology for Preparing the Emulsions

The emulsions are prepared as follows:

A part of the water and the surfactant (B) are mixed in an IKA® reactor;
the aminopolyorganosiloxane (A) is added to this mixture, this incorporation being carried out with stirring so as to obtain an oil-in-water emulsion; and
at the end of the introduction of the aminopolyorganosiloxane and after homogenization, the final dilution of the emulsion and the addition of the additives (for example, biocides) are carried out.

### 2) Comparative Example 1

Preparation of an oil-in-water emulsion (according to the protocol described in paragraph 1) of an aminosilicone oil (A)=Rhodorsil® 21648 (sold by the company Rhodia, average viscosity between 1500 and 3500 mPa·S)+7% by weight of surfactant (B) relative to the aminosilicone oil−surfactant (B)=Rhodasurf® ROX aqueous solution containing 85% of an ethoxylated fatty alcohol, sold by the company Rhodia.

This emulsion is diluted so as to obtain an emulsion containing 5% by weight of silicones.

### 3) Example 2

### Invention

Preparation of an oil-in-water emulsion (according to the protocol described in paragraph 1) of an aminosilicone oil (A)=Rhodorsil® 21648 (sold by the company Rhodia)+2% surfactant by weight relative to the aminosilicone oil−surfactant (B)=Rhodasurf® ROX aqueous solution containing 85% of an ethoxylated fatty alcohol, sold by the company Rhodia.

This emulsion is diluted so as to obtain an emulsion containing 5% by weight of silicones.

### 4) Example 3

### Invention

Preparation of an oil-in-water emulsion (according to the protocol described in paragraph 1) of an aminosilicone oil (A) Rhodorsil 21643 (sold by the company Rhodia, viscosity 300 mPa·S, nitrogen content of approximately 0.2% by weight relative to the weight of the oil)+2% surfactant by weight relative to the aminosilicone oil−surfactant (B)=Rhodasure® ROX aqueous solution containing 85% of an ethoxylated fatty alcohol, sold by the company Rhodia.

This emulsion is diluted so as to obtain an emulsion containing 5% by weight of silicones.

### 5) Textile Support Tested

Calendered polyamide 6.6 fabric without treatment—90 g/m².

### 6) Treatment of a Textile Substrate

A piece of fabric approximately 1 meter by 1.5 meters is cut lengthwise with scissors. The piece of fabric is folded so as to obtain squares of approximately 20×20 cm, and the fold lines are cut with a cutter.

The samples of fabrics (polyamide calendered on one face) are then treated:
a) by direct application of the aqueous solutions of waterproofing agent at 5% of dry extract (emulsion diluted ten times), homogeneously on the noncalendered face,
b) by spraying:

The fabric is placed facing the spray, about twenty centimeters from the spray nozzle. The fabric is sprayed, beginning with the upper corner. Once the fabric has been entirely wetted, three or four sprays are added at the center of the fabric and the fabric is immediately hung at an angle on a drying screen for 24 hours before testing it, or
c) by soaking:

The fabric is folded and completely soaked in the pot containing the waterproofing agent. It is subsequently unfolded and folded again in the opposite direction, such that the inside faces in the previous folding are on the outside. The fabric is then completely resoaked. The fabric is immediately hung at an angle on a drying screen for 24 hours before testing it.

The waterproofing agents are tested after drying for 36 hours, optionally followed by a period of one hour in a tumble dryer at 60° C.

### 7) Detergent Washing

### Textile Maintenance

A PROLINE WMP-500C domestic machine is used to test the fabrics treated according to the procedure described in paragraph 6). Washing program No. 8 at 40° C. (delicate synthetics—40 minutes) is used. A detergent dose of 4 g/L is used (i.e., for a volume of 8 L, a dose of approximately 35 g per cycle). The detergent used is standard (nonphosphated ECE). The samples are therefore subjected to a series of machine wash cycles.

### 8) Evaluation of the Water-Repellent Properties

### Spray-Test According to Standard AATC Test Method 22-1996

The samples are tested at ambient temperature (23° C.-RH 50%) after a drying phase after application and 4 hours after washing. The evaluation is carried out on a set of 20 cm×20 cm textile remnants. The fabric is inclined at 45° during the experiment in order to allow the water to run off. The fabric, still gripped between the rings on the corner of a table, is beaten twice.

Then, a mark is assigned according to the following criteria:

5.0=No trace of water visible to the eye.
4.8=Minuscule droplets are trapped between the fibers of the fabric.
4.5=Small droplets (approximately 5 to 10) are distributed at the surface of the fabric.
4.2=Small droplets (approximately 15 to 20) are distributed at the surface of the fabric.
4.0=Numerous droplets are visible at the surface of the fabric.
3.8=Droplets at the surface of the fabric and minuscule traces of diffusion of water in the fabric are visible.
3.5=Droplets at the surface of the fabric and traces of diffusion of water in the fabric are visible.
3.0=Drops at the surface of the fabric and the impacts of the jets of water in the fabric are visible.
2.5=Drops and a broad discontinuous diffusion of water in the fabric are visible.
2.0=Drops and a virtually continuous diffusion of water in the fabric are visible.
1.5=A light film of water at the surface and a continuous diffusion film in the fabric (surface under the jet) are visible.
1.0=A continuous film of water at the surface and in the fabric are visible under the jet. One or two droplets pass through the fabric when it is beaten.
0.5=A continuous film of water at the surface and capillary diffusion of the water throughout the fabric are visible. One or two droplets pass through the fabric when it is beaten.
0.0=A continuous film of water at the surface and capillary diffusion of the water throughout the fabric are visible. Large drops pass through the fabric when it is beaten.

### Results:

The spray-test results as a function of the amount of surfactant are reported in table 1.

TABLE 1

| Reference | Spray test |
|---|---|
| Example 1 | 0.0 |
| (comparative) | |
| Example 2 | 4.5 |
| (invention) | |

At a high content (7%) of surfactant relative to the aminosilicone oil (comparative), an absence of water-repellency is observed after a first treatment (initially).
At a low content (2%) of surfactant relative to the aminosilicone oil (invention), the water-repellency is obtained from the first treatment (initially) onward.

TABLE 2
Spray-test results after a series of machine wash cycles (durability)

| | | After 1 | After 2 | After 3 |
|---|---|---|---|---|
| Reference | Initial | WASH | WASHES | WASHES |
| Example 1 | 0.0 | 4.8 | 4.8 | 3.5 |
| (comparative) | | | | |
| Example 2 | 4.5 | 4.8 | 4.8 | 4.2 |
| (invention) | | | | |
| Example 3 | 3.5 | 4.0 | 3.8 | 3.8 |
| (invention) | | | | |

At a low surfactant content (invention), it is noted that the water-repellent properties are obtained from the first treatment onward and are long-lasting, whereas, with the comparative, it is necessary to wash the fabric at least once in order to give it back acceptable water-repellent properties.

1.-9. (canceled)

10. Oil-in-water siloxane emulsion, which comprises:
at least one aminopolyorganosiloxane (A),
water,
at least one surfactant (B), and
optionally, at least one polyorganosiloxane resin (C),
optionally, at least one epoxy-functionalized polyorganosiloxane (D), and
optionally, at least one additive (E) selected from the group consisting of biocides, antifungal agents, antifoams, antioxidants, film-forming polymers, thickeners and wetting agents,
with the proviso that:
1) the surfactant (B) is present at up to 2.5% by weight, relative to the sum of the weights of the constituents (A), (C) and (D),
2) the amounts of surfactants (B) and of water are such as to provide an oil-in-water emulsion, and
3) said emulsion is devoid of any protonating agent.

11. The oil-in-water siloxane emulsion composition as defined by claim 10, devoid of any protonating agent selected from the group consisting of formic acid, acetic acid, sulfuric acid, hydrochloric acid and citric acid.

12. The oil-in-water siloxane emulsion composition as defined by claim 10, which comprises:
100 parts by weight of at least one aminopolyorganosiloxane (A), water,
at most 2.5 parts by weight of at least one surfactant (B), and
0 to 600 parts by weight of at least one polyorganosiloxane resin (C),
0 to 5 parts by weight of at least one additive (E) selected from the group consisting of biocides, antifungal agents, antifoams, antioxidants, film-forming polymers, thickeners and wetting agents,
With the proviso that:
1) the surfactant (B) is present at up to 2.5% by weight, relative to the sum of the weights of the constituents (A) and (C), and
2) the amounts of surfactants (B) and of water are such as to provide an oil-in-water emulsion.

13. The oil-in-water siloxane emulsion composition as defined by claim 10, wherein the aminopolyorganosiloxane (A) comprises siloxyl units, which may be identical or different, of general formula (I):
R¹ₐR²_{b}SiO_{4-(a+b)/2} (I)
in which:
(a) a=0, 1, 2 or 3,
b=0, 1, 2 or 3,
a+b≦3,
(b) the symbols R¹, which may be identical or different, are each a monovalent hydrocarbon-based radical selected from among linear or branched alkyl radicals having from 1 to 40 carbon atoms, and —OR³ radicals, in which R³=H or a linear or branched alkyl radical having from 1 to 40 carbon atoms, and
(c) the symbols R², which may be identical or different, are each a radical of general formula (II):
—R⁴—N(R⁵)(R⁶) (II)
in which:
the symbol R⁴ is a divalent hydrocarbon-based radical having from 1 to 40 carbon atoms,
the symbol R⁵ is a hydrogen atom or a monovalent hydrocarbon-based radical having from 1 to 40 carbon atoms,
the symbol R⁶ is a hydrogen atom or a radical of formula (III):
—[R⁷—N(R⁸)]ₓR⁸
the symbol R⁷ is a divalent radical of formula (IV):
[C(R⁸)(R⁸)—]_{y}
0≦x≦40,
y=1, 2 or 3,
the symbol R⁸ is a hydrogen atom or a monovalent hydrocarbon-based radical having from 1 to 40 carbon atoms, and
(d) at least one siloxyl unit bearing an R² radical is present per molecule.

14. The oil-in-water siloxane emulsion composition as defined by claim 13, in which the R² radical is selected from the group consisting of:
—(CH₂)₃—N(R⁵)₂; —(CH₂)₃—N(R⁵)₂— and —(CH₂)₃—N(R⁵)—(CH₂)₂—N(R⁵)₂
wherein the symbol R⁵ is a hydrogen atom or a monovalent hydrocarbon-based radical having from 1 to 40 carbon atoms.

15. The oil-in-water siloxane emulsion composition as defined by claim 10, in which the polyorganosiloxane resin (C) is an MQ silicone resin.

16. A method for the long-lasting waterproofing of a substrate, said substrate being porous or nonporous, absorbent or non-absorbent, comprising treating said substrate with an oil-in-water siloxane emulsion as defined by claim 10.

17. The method as defined by claim 16, wherein the substrate is a textile material.

18. A long-lasting waterproofed porous or nonporous, absorbent or nonabsorbent substrate that has been treated with an oil-in-water siloxane emulsion as defined by claim 10.

19. Oil-in-water siloxane emulsion, consisting essentially of:
at least one aminopolyorganosiloxane (A),
water,
at least one surfactant (B), and
optionally, at least one polyorganosiloxane resin (C),
optionally, at least one epoxy-functionalized polyorganosiloxane (D), and
optionally, at least one additive (E) selected from the group consisting of biocides, antifungal agents, antifoams, antioxidants, film-forming polymers, thickeners and wetting agents,
with the proviso that:
1) the surfactant (B) is present at up to 2.5% by weight, relative to the sum of the weights of the constituents (A), (C) and (D),
2) the amounts of surfactants (B) and of water are such as to provide an oil-in-water emulsion, and
3) said emulsion is devoid of any protonating agent.
